(19) United States
(12) Patent Application Publication
(10) Pub. No.: US 2020/0172069 A1
(43) Pub. Date: Jun. 4, 2020

(54) INTELLIGENT VACUUM PUMP WITH LOW POWER CONSUMPTION

(71) Applicants: KABIR BHANDARI, NEW DELHI (IN); RAJESH KUMAR SAHOO, GURGAON (IN); PRAVEEN GUPTA, GURGAON (IN); SUMIT RAJPAL, GURGAON (IN)

(72) Inventors: KABIR BHANDARI, NEW DELHI (IN); RAJESH KUMAR SAHOO, GURGAON (IN); PRAVEEN GUPTA, GURGAON (IN); SUMIT RAJPAL, GURGAON (IN)

(21) Appl. No.: 16/779,707

(22) Filed: Feb. 3, 2020

Related U.S. Application Data
(63) Continuation-in-part of application No. 15/327,481, filed on Jan. 19, 2017, now abandoned.

(51) Int. Cl. B60T 8/44; B60T 13/52; B60T 15/02

(52) U.S. Cl. CPC B60T 8/448; B60T 15/025; B60T 13/52

(57) ABSTRACT

A vacuum pump for automobiles used for brake application is provided wherein a method of reducing power consumption and running torque in a vacuum pump of a motor vehicle is explained. The present invention also provides a vacuum pump for automobiles comprising an actuator, a new vane locking assembly, a new vane and rotor assembly, a new non return valve assembly, the controlled oil supply means and a reed stopper assembly that reduces power loss and unnecessary frictional forces and to maintain a controlled oil supply to the vacuum pump.

### CROSS REFERENCE TO RELATED APPLICATION

This application is a Continuation in Part of U.S. application Ser. No. 15/327,481, a National Stage Entry of PCT/IB2015/055471 which in turn depends from and claims priority of Indian Patent Application No: 2048/DEL/2014 filed Jul. 19, 2014 the entire contents of which are incorporated herein by reference.

### FIELD OF THE INVENTION

The present invention relates to an intelligent vacuum pump controlling apparatus for automobiles braking system. More particularly, this invention relates to a method of reducing power consumption and running torque in a vacuum pump of automobiles. The present invention also provides a vane locking mechanism to reduce power loss and regulate oil supply to the vacuum pump to prevent additional power losses due to continuous oil supply.

### BACKGROUND OF THE INVENTION

Brakes are mechanical devices which increase the frictional resistance that retards the rotational motion of the wheels. However, in automobiles vacuum assisted hydraulic brake system is utilized to generate a constant vacuum in the brake booster by the engine for easy application of greater resistance to the wheel.

In general, the brake system in an automobile comprises of a brake pedal, a power brake booster, a master cylinder, hydraulic lines, wheel cylinder and disc brakes and/or drum brakes. A vacuum pump is present in the brake system to provide the vacuum power that provides maximum output resistance with minimum mechanical input. The vacuum pump is activated continuously when the engine is running and creates a vacuum to the power brake booster. Power brake boosters provide the pneumatic boosting to enhance the force from the brake pedal by utilizing the pressure difference between the vacuum chamber and the working chamber. The generated force pushes the disc brakes and/or drum brakes to generate an adequate braking torque for the vehicles.

One of the main advantages of using the vacuum brake system in a motor vehicle is to provide the required force at the brakes of a motor vehicle. When a driver presses the brake pedal they get assistance from the braking system without which the driver has to provide greater resistance i.e. a user shall feel the brake pedal very hard so has to input greater force. Normally the pressure decreases in the brake booster when heavy braking is applied, which further causes a decrease in amplification during braking. This condition of low pressure in the brake booster during the condition of heavy braking is removed by using an auxiliary vacuum pump which can maintain, or even increase the amplification during a heavy braking phase.

During operation of the vacuum pump, oil is drawn from the oil reservoir into the feed valves by the vacuum generated by the pump. When the vacuum pump is in the pressure mode, the pressurized oil reservoir forces oil to the side feed valves and into the pump. The oil flow rate from the oil reservoir is controlled by the oil pump. After the booster attains the full vacuum, the pump still rotates and allows the oil flow into the pump; in such cases the usual vacuum pump takes extra power from the engine. At the same time the oil pump in the engine also continuously supplies oil into the vacuum pump which causes additional power loss.

German patent No. 27 16 471 discloses a brake system of this type wherein a compressed air pump can be connected to a high pressure chamber of a brake power booster by way of an electrically operable solenoid valve. The pressure in the high pressure chamber is adjusted by way of a pulsed electric actuation of the solenoid valve. A low pressure chamber is directly connected to a vacuum pump.

A disadvantage of this known brake system is the use of a solenoid valve which is complicated and costly and requires an electric or electronic controlling or regulating unit for the actuation. The compressed air pump as well as the vacuum pump is constantly in operation which maintains the maximum possible excess pressure or vacuum. This results in high energy consumption as the full pump rate is provided while operating the braking system.

Therefore, the object of the present invention is to overcome unnecessary energy loses and provide a durable, cost effective and energy saving braking device and system.

U.S. Pat. No. 2,240,792 disclosed the self-adjustment concept of brakes to automatically maintain a constant clearance between the surfaces of the friction material and the brake drum when the brakes are released, to automatically compensate for the wearing off of these surfaces. A self adjustment means and thermostatic means are disclosed to compensate the wear due to friction and to compensate for the heat resulting from the frictional elements. The fluid pressure adjustment is provided to compensate the friction means.

US 20140334960 discloses a vacuum pump having a casing defining a cavity having an inlet and an outlet, wherein the cavity contains a rotor and a vane slidably mounted to the rotor. The rotor extends through a side of the casing to the exterior thereof and is provided with a coupling arrangement to couple the rotor to a drive member. The vacuum pump disclosed focuses on rotor coupling but fails to address the problem of optimizing the flow of oil as there is no provision of vane locking system. Another disadvantage associated with this is that the disclosed vacuum pump runs continue to create vacuum with engine camshaft.

U.S. Ser. No. 10/119,541 teaches a pump device having a drive shaft which has a drive section that can be coupled with a drive system. The pump device includes a vacuum pump that can be driven by the drive shaft. The vacuum pump includes a rotor and at least one blade that can be moved in radial direction in the rotor and that divides pressure chambers. The pump device also includes a lubrication pump that can be driven by the drive shaft. The vacuum pump is arranged between the drive section and the lubrication pump. A locking device is provided between the rotor and the lubrication pump in which, when activated, the at least one blade remains in a radially internal position when the rotor is rotating. There is extra drive section having sprockets which is coupled with the engine drive system. The vane blades are arranged parallel to each other within same slot of rotor without any external spring force and hence no mechanism to lock in a position. The actuation system in this citation is fully hydraulic which get power from another external lubrication oil pump, having its own disadvantages. There is no vane locking slot and as the control element moves downwards then due to selection of center of gravity the both blades come inwards while in rotation. The proposed vacuum pump is in axial direction between drive section and lubrication pump. There are two different channels for oil, one for vacuum pump lubrication and other for operating the activation valve ram by hydraulic pressure, thus requiring multiple inlets and chances of oil leakage within the pump.

US20130228241 proposes an apparatus that creates a backward pressure in fluid traversing a pipe, wherein the backward pressure within the pipe provides compression to the fluid effectively compressing entrapped gas bubbles within the fluid, allowing more accurate water meter measurements. Moreover, the apparatuses of the present invention provide backflow prevention. Systems and methods for managing fluids are further provided. The apparatus has shaft of bushing to hold the spring alignment. The apparatus has a plunger diaphragm which is connected to shaft by means of threaded end disposed in it. The apparatus its used to help in precisely measuring the flow rate of fluid in pipes by compressing the air bubbles in the water or fluid.

Conventional vacuum braking system suffers the problem of overheating due to improper oil flow rate and friction. For the reliability of the vacuum braking system more accurate vacuum pressure system is needed.

Therefore, there is a need for a reliable and efficient vacuum pump system which reduces the power loss in the ideal working condition i.e. when vacuum is reached in a brake booster tank to a desired value then actuator moves the shaft in downward direction which causes the disengagement of the vanes in-to the housing wall and cuts or minimizes the oil supply in to the pump. This causes the reduction of frictional losses between the vane tip and the housing wall. In addition to this the oil supply is stopped or minimized which causes low power consumption in oil pump. This causes low torque to operate the pump and causes low power consumption. The oil flow regulation can be done through various ways like using tapper sleeve, actuating rod, sleeve with groove or any kind of other mechanical/electrical controlling device and which can be actuated forward or backward through vacuum, pressure, oil pressure regulator valve, Solenoid valve etc. or any other actuating method.

### OBJECT OF THE INVENTION

The main object of this invention is to provide an improved configuration of a vacuum pump in the motor control apparatus of a motor vehicle.

Yet another object of this invention is to provide an improved vacuum pump in the motor control apparatus of a motor vehicle, which consumes less power.

Yet another object of this invention is to provide a novel vane locking mechanism for reduction of frictional losses between the vane tip and the housing wall, additionally maintaining a controlled oil supply causing low power consumption in oil pump.

Yet another object of this invention is to provide an optimized oil supply into the pump which reduces the oil pump efforts and results low power consumption.

### SUMMARY OF THE INVENTION

The present invention relates to an improved vacuum pump of a motor vehicle. The invention provides for a method of reducing power consumption and running torque in the vacuum pump of a motor vehicle. The improved configuration of vacuum pump results into lesser friction loss by implementing an improved feature for oil management, friction management within the vacuum pump assembly.

In one aspect of the present invention, provides a vacuum pump for automobiles comprising an actuator assembly of a diaphragm, a spring and a movable vertical shaft, connecting a brake booster tank and an oil supply path; a vane locking assembly; a vane and rotor assembly; a non-return valve assembly; the controlled oil supply means; and a reed stopper assembly.

The actuator assembly has a movable vertical shaft (actuator shaft/rod) with a stepped diameter with a narrow diameter at the tip and a preceding broader diameter. The vane locking assembly, further comprises a plurality of stoppers resting on a plurality of disc springs, a plurality of vane locking adaptors connected to a plurality of extension springs such that the assembly engaging the movable vertical shaft on actuation, the movable vertical shaft having a stepped diameter, the narrow diameter is engaged in vane locking but as the movable vertical shaft moves further downwards under actuation, the broader diameter engages in vane locking and causes said plurality of vanes locking adaptors to move outwards and strike with the plurality of vanes to block movement due to force applied by the plurality of disc springs. This reduces power loss and regulates the oil supply to the vacuum pump to prevent additional power loss due to continuous oil supply.

The vane and rotor assembly, further comprises a housing connecting the engine, receiving oil from oil gallery and supporting: a knob that connects the engine camshaft and transmits power and torque to the vacuum pump; a rotor causing the movement of the vane in rotary and reciprocating motion; a locking cap restricting movement of the rotor in the axial direction preventing the knob to come out from the rotor; and vane tip sweeps the air and oil thereby making a closed chamber; the non-return valve (NRV) assembly further comprising an inlet connector, a diaphragm, a spring and a spring retainer. The diaphragm is resting on said inlet connector through the action of said spring which is supported by said spring retainer allowing the air in one direction only; the controlled oil supply means provides an optimized oil flow rate upon achieving a desired vacuum state in the brake booster tank; and the reed stopper assembly further comprising a sealing reed, a reed stopper and a spring washer, screwed on housing to allow oil exit and prevents air leakage.

A method of reducing power loss and regulate controlled oil supply to the vacuum pump for automobiles to prevent additional power loss due to continuous oil supply via vane locking mechanism, the method comprising the steps of: activating actuator by achieving a desired vacuum is reached in the brake booster tank that pushes the diaphragm into downward direction; that allows the spring to compress and the shaft starts moving into downward direction, due to stepped diameter of the shaft; engaging vane locking assembly to initially engage the lower diameter as the shaft move in downward direction; and further engaging the larger diameter in vane locking and causing said plurality of vane locking adaptors to move into outward direction that strike with the plurality of vanes to block movement due to force applied by the plurality of disc springs.

The present invention utilizes the combined effects of less friction between the vane slider and the housing and optimized oil flow rate from the pressurized oil reservoir which results in less power consumption and running torque in more efficient and effective way over the existing vacuum pumps.

Various general and specific objects and advantages of the invention will become apparent when reference is made to the following description of the invention considered in conjunction with the related drawings.

### BRIEF DESCRIPTION OF THE DRAWINGS

A complete understanding of the system and method of the present invention may be obtained by reference to the following drawings:

FIG. 1 is an exploded view of a conventional vacuum pump.

FIG. 2a is a diagrammatic view of a vacuum pump according to the present invention.

FIG. 2b is a block diagram depicting positioning and connectivity of a vacuum pump according to the present invention.

FIG. 3a is a plan view of a conventional rotor assembly.

FIG. 3b is a plan of a rotor assembly according to the present invention.

FIG. 3c shows diagrammatic representation of vane locking assembly at low vacuum.

FIG. 3d shows diagrammatic representation of vane locking assembly at full vacuum.

FIG. 3e shows diagrammatic representation of vane locking mechanism.

FIG. 3f shows diagrammatic representation of vane locking mechanism with respect to the position of vertical shaft.

FIG. 3g shows diagrammatic representation of vane locking mechanism with respect to the position of vertical shaft.

FIG. 4 is a plan view of the vane locking sub assembly according to the one embodiment of the present invention.

FIG. 5 is a top view of a vane locking assembly according to the one embodiment of the present invention.

FIG. 6 is a side view of a rotor according to another embodiment of the present invention wherein an oil passage groove is provided on the wall of the rotor.

FIG. 7 is a top view of the rotor according to the present invention wherein the double slot for vane and an oil passage groove is provided in the center of the rotor as well.

FIG. 8 is an exploded top view of the vane and rotor assembly.

FIG. 9 is a plan view of the Non Return Valve (NRV) assembly.

FIG. 10 is a plan view of the reed stopper assembly.

FIG. 11 is a plan view of the vacuum pump.

FIG. 12a is a diagrammatic representation of the vane locking mechanism, controlled oil supply under actuation according to present invention.

FIG. 12b is a diagrammatic representation of the arrangement of vacuum pump with external actuation system, controlled oil supply from engine and the connectivity to the engine camshaft according to present invention.

FIG. 12c is a diagrammatic representation of the vane locking mechanism, controlled oil supply according to present invention.

FIGS. 12d and 12e provide a diagrammatic representation of the vane locking mechanism, controlled oil supply under actuation according to present invention.

FIG. 13 shows step wise mechanism of the vane locking at full and low Vacuum.

FIG. 14 is a comparative graph to show percent reduction in torque between conventional vacuum pump and novel vacuum pump according to the current invention.

### DESCRIPTION OF THE PREFERRED EMBODIMENTS

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Following reference numerals have been used while describing the invention with respect to the drawings.
1: Housing
2: Cover
3A, 3B: Vanes
4A, 4B: Compressible springs
5: Rotor
6: Knob
7: Locking cap
8: Inlet connector
9: Diaphragm
10: Spring
11: Spring retainer
12: Sealing ring
13: Sealing reed
14: Reed stopper
15: M6 screw
16: M4 screw
17: Spring washer
18: Sealing ring
19: Vane locking adaptors
20: Extension springs
21: Cover O-ring
23: Piston O-ring
24: Actuator/Actuator assembly
25: Oil filter
26: Stoppers
27: Disc springs
28: Rod/Piston/Vertical shaft
29: Slot/Double slot for Vane
30: Oil passage groove in center
31: Diaphragm
32: Oil passage groove on wall
33: Oil inlet orifice/rotor oil hole
34: Spring
35: Oil supply means
36: Closed chamber
37/37A, 37B: Vane tips
41: conventional Casing
42: conventional Cover
43: conventional Vane
44: conventional Vane slider
45: conventional Rotor
46: conventional Knob
47: conventional Locking cap
48: conventional Inlet connector
49: conventional Diaphragm
50: conventional Spring
51: conventional Spring retainer
52: conventional Sealing ring
53: conventional Sealing reed
54: conventional Reed stopper
55: conventional M6 Screw
56: conventional M4 Screw
57: Engine
58: Oil gallery
59: Engine camshaft
60: Oil supply path
61: Suction Port

In an embodiment of the present invention is proposed a vacuum pump for an automobile engine comprising an actuator assembly 24 comprising of a diaphragm 31, a spring 34 and a movable vertical shaft or actuator rod 28, and an oil supply path 60; a vane locking assembly comprising a vane locking sub-assembly assembled with a rotor 5; a non-return valve assembly (NRV); a controlled oil supply means 35; and a reed stopper assembly. The movable vertical shaft 28 has a stepped diameter with a narrow diameter at tip and a preceding broader diameter. The rotor 5 is provided with a plurality of vanes 3A, 3B, each vane of said plurality of vanes connected to a plurality of compressible springs 4A, 4B thus forming a vane and rotor assembly. The vane locking sub-assembly comprises a plurality of stoppers 26 resting on a plurality of disc springs 27, a plurality of vane locking adaptors 19 connected to a plurality of extension springs 20; the vane and rotor assembly, further comprises a housing 1 and a knob 6 with a locking cap 7. The rotor 5 causes the movement of the vane in a rotary and reciprocating motion; the locking cap 7 restricts movement of the rotor in axial direction preventing the knob 6 from coming out of the rotor; and vane tips 37A, 37B sweep the air and oil by making a closed chamber 36. The non-return valve (NRV) assembly comprises an inlet connector 8, a diaphragm 9, a spring 10 and a spring retainer 11 wherein said diaphragm 9 is resting on said inlet connector 8 through the action of said spring 10 which is supported by said spring retainer 11 allowing the air in one direction only. The controlled oil supply means 35 provides an optimized oil flow rate. The reed stopper assembly comprises a sealing reed 13, a reed stopper 14 and a spring washer, screwed on to the housing 1 to allow the oil to exit and prevent air leakage.

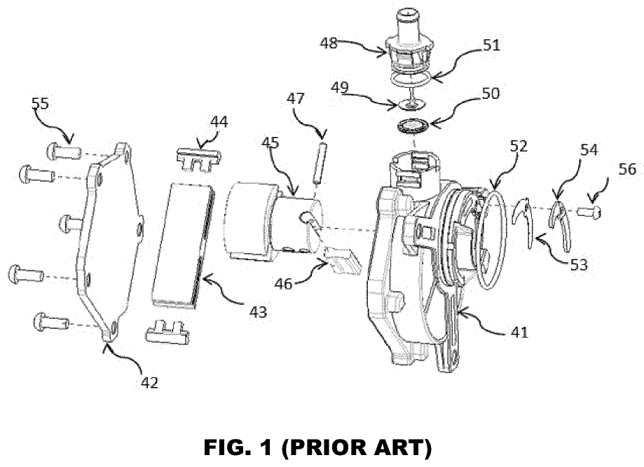

FIG. 1 is an exploded view of conventional, state of the art vacuum pump. The vacuum pump comprises a casing 41 provided with a rotor 45 and a vane 43. The vane 43 having vane slider 44 is slidably supported in a recess of the rotor 45. The casing 41, rotor 45, vane 43 and vane slider 44 enclosed with the cover 42 and form the pump chamber. The sealing ring 52 adapted, in use, to provide a seal against the engine cylinder head. In the embodiment shown the rotor 45 is circular and the recess bisects the rotor 45. The rotor 45 is positioned in the casing 41 such that rotational axis thereof lies on a plane of symmetry of the casing 41. The rotor 45 is positioned on this plane such that the edge of the rotor 45 almost touches the casing 41. In the arrangement shown, the rotor can be said to be positioned in an upper portion of the casing 41. The aforementioned plan of symmetry extends between top centre and bottom centre of the casing 41.

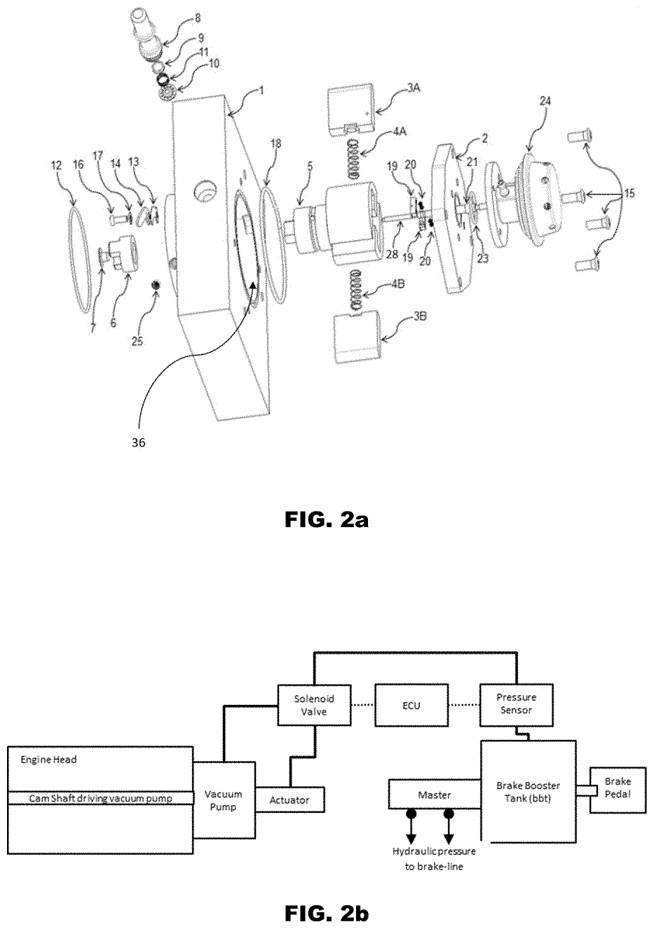

FIG. 2a is a diagrammatic view of a vacuum pump according to the present invention. housing 1 with chamber 36 is assembled with a rotor 5 and an actuator 24 operated with an external actuation system. Housing 1 is connected to an engine and receives oil from the oil gallery. It supports all child parts and having profile. Knob 6 is connected with the engine camshaft and transmits power and torque to vacuum pump. In other words, it enables the rotor 5 to rotate as camshaft rotates. The locking cap 7 restricts the knob 6 to move in axial direction and in this way; it prevents the knob 6 to come out from the rotor 5.

As depicted in FIG. 2b the block diagram shows a vacuum pump is postioned over the engine head and driven by cam shaft. Its hose pipes (thick black line) shows its connection to brake booster tank.

Further the vacuum in brake booster tank (BBT) is used for braking system. Here the Electronic Control Unit (ECU) controls the solenoid valve and when pressure sensor senses the desired level of vacuum in the BBT, then its value causes the solenoid valve to open. This causes the actuator to push the movable vertical shaft inside the pump vane locking mechanism. Further oil enters from the engine head mounitng to the pump body by the interface inbetween them and overlapping holes on both component's body. Pump is driven through camshaft of the vehicle engine. The oil enters from the engine head to the pump inside and rotational motion with vane inside the pump chamber causes vacuum generation. Air is sucked from the brake booster and vacuum is created inside the brake booster. When driver press the pedal, then due to vacuum inside the brake booster causes pressure difference and this multiplies the total mechanical force of the pedal several times and pushed the master cylinder rod. Master cylinder delivers the hydraulic oil pressure to the tires via brake lines. This is the braking principle of vacuum pump.

In current invention the external actuation system is introduced which is operated when the full vacuum/desire vacuum is achieved in the brake booster tank (i.e. when pedal not pressed). This is controlled by a pressure sensor which gives the feedback of vacuum level inside the brake booster tank to the ECU (electronic control unit). When a desired vacuum is achieved in the booster, ECU gets signal from the pressure sensor and operates the solenoid valve, which cause the vacuum hose pipe disconnects from the brake booster and brake booster is now connected to external actuator hose pipe. So, the vacuum causes the external actuation to work and it pull the movable vertical shaft downwards causes the vane inside the vacuum pump get locked, overall result in reduction of power consumption when brake pedal is not in used.

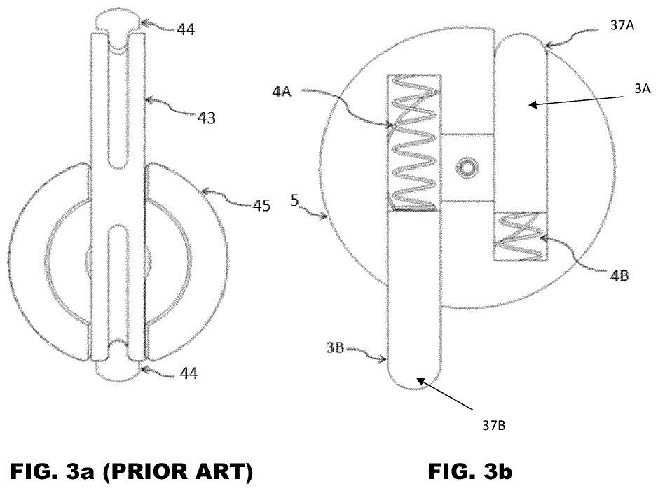

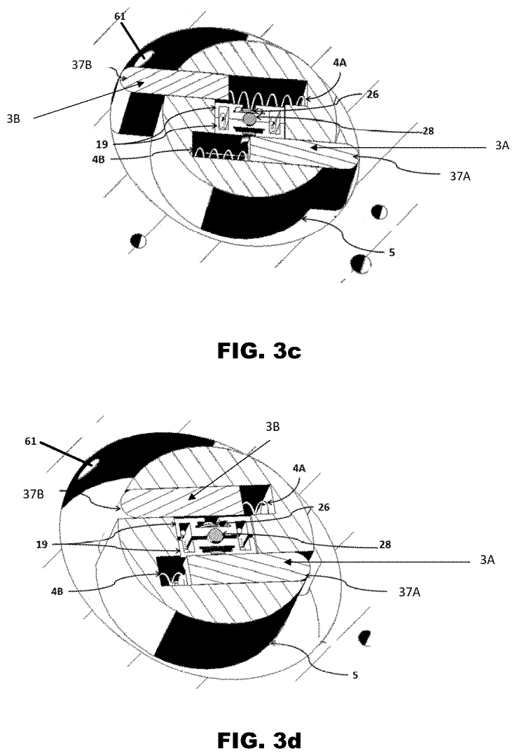

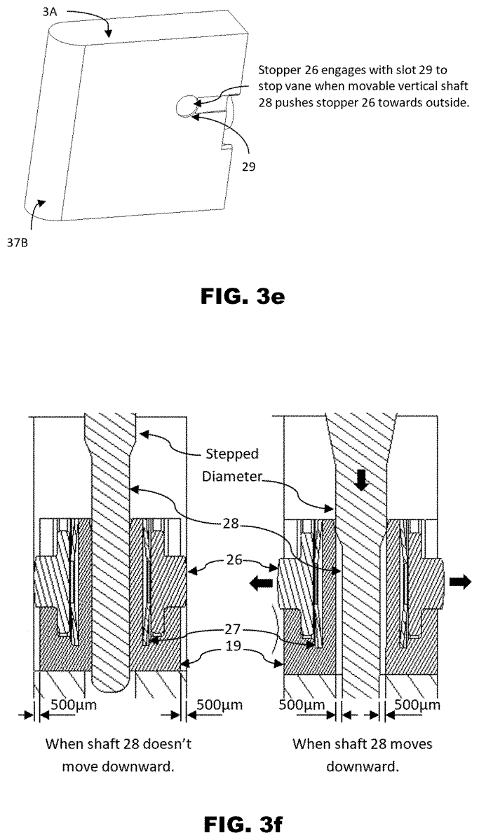

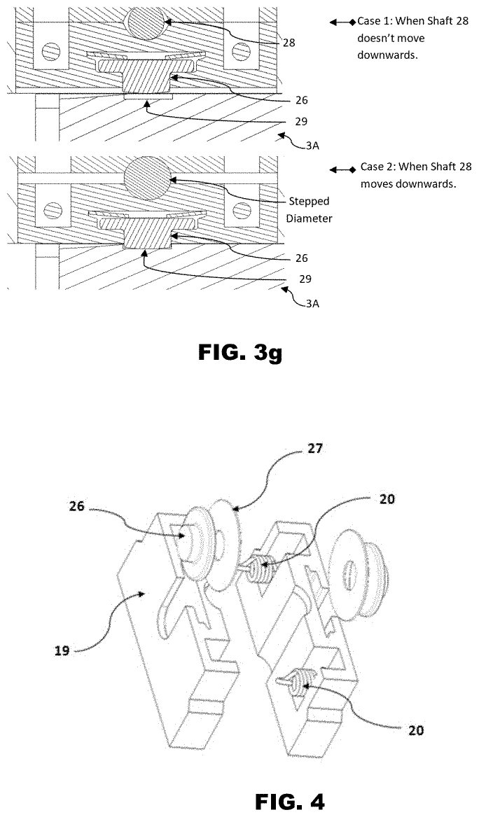

FIG. 3a is a plan view of a conventional rotor 45 wherein a single vane 43 is provided with a plurality of vane sliders 44.

FIG. 3b is a plan view of a rotor assembly according to the present invention wherein the rotor 5 is provided with plurality of vanes 3A, 3B. Vane 3A having tip 37A, is connected to compressible spring 4A. Vane 3B having tip 37B, is connected to compressible spring 4B.

FIG. 3c represents vane locking assembly at low vacuum. When vacuum reduces in brake booster tank, actuator gets signal and actuator rod 28 moves upwards resulting into adapters 19 moving inwards, while springs 4A, 4B cause vanes 3A, 3B pushed outwards towards the chamber walls. When vanes are pushed outwards, vacuum is generated within the pump.

Referring to FIG. 3d, when full vacuum is achieved in brake booster pump, the actuator gets signal and vertical shaft/rod 28 moves downwards resulting into adapters 19 moving outwards under pressure of said vertical shaft/rod 28. Adapters 19 cause stoppers 26 to move outwards towards vane 3A, 3B. Stoppers 26 get engaged inside the vane 3A, 3B via a slot on its panel surface resulting in the locking of 3A, 3B inside rotor 5 at their initial position. This reduces the vacuum in brake booster tank. As shown in FIG. 3e, during vane locking, stopper 26 engages with slot 29 to stop vane when movable vertical shaft 28 pushes stopper 26 towards outside. When actuator rod 28 is pulled downwards it causes the oil restriction by closing the oil ports 33 inside the rotor which prevents further flow of oil from hole 33 to the pump chamber. As actuator rod 28 move towards hole 33, the stepped diameter of the actuator rod 28 causes the vane locking adaptors 19 to move outwards direction towards slot in vane 3A, 3B.

FIG. 3f elucidates that due to stepped diameter of rod actuator 28, its downwards motion causes maximum displacement of 500 μm of stoppers 26 outwards, which in turn gets locked inside the slot in vane 3A and similarly for vane 3B during their transitional movement back & forth in rotor slot 29. Due to oval shape arrangement entry for actuator rod 28 inside the vane locking mechanism, the stepped diameter cause the stoppers 26 to move outwards, as shown in FIG. 3g. When vane 3A matches its slot in vane with stoppers 26, the vane gets locked at the same position and same goes for vane 3B.

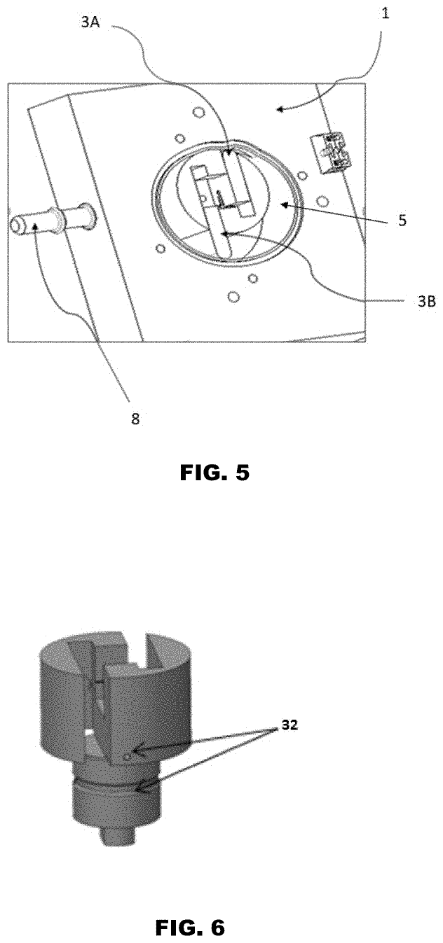

FIG. 4 is a plan view of the vane locking sub assembly which consists of a plurality of vane locking adaptors 19, a plurality of disc springs 27, a stopper 26, and an extension type spring 20.

FIG. 5 is a top view of vane locking assembly that encloses the vane locking sub-assembly and assembled in rotor 5 through dove tail joint, and an inlet connector 8.

FIG. 6 is a side view of a rotor according to another embodiment of the present invention wherein an oil passage groove 32 is provided on the wall of the rotor.

FIG. 7 is a top view of the rotor according to the present invention wherein the double slot 29 for vane and an oil passage groove 30 is provided in the center of the rotor as well.

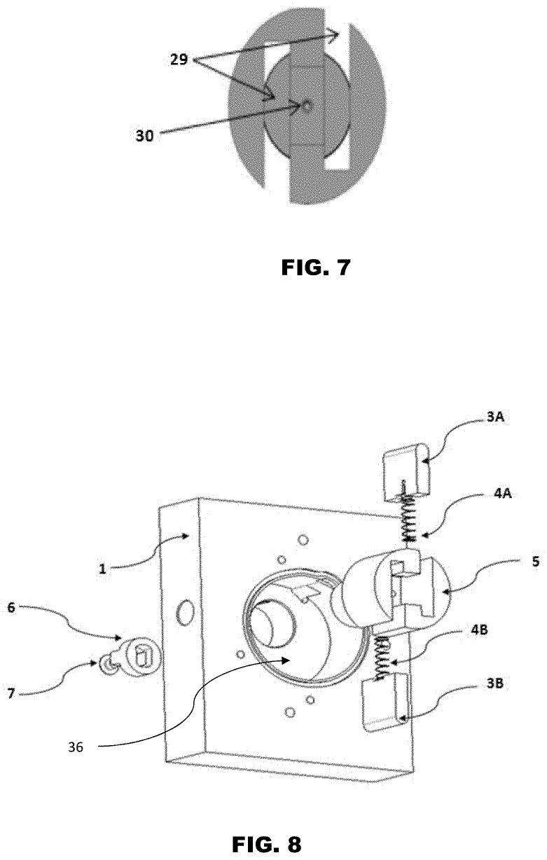

FIG. 8 is a top view of the vane and rotor assembly comprising the housing 1, wherein rotor 5 is assembled through journal bearing and it rotates by the help of knob 6 which is fixed in rotor 5 by locking cap 7. Vanes 3A, 3B are fitted in the rotor 5 by sliding fit with the aid of spring vanes 4A, 4B such that the reciprocation motion of vanes 3A, 3B can be achieved through cam mechanism of hosing profile.

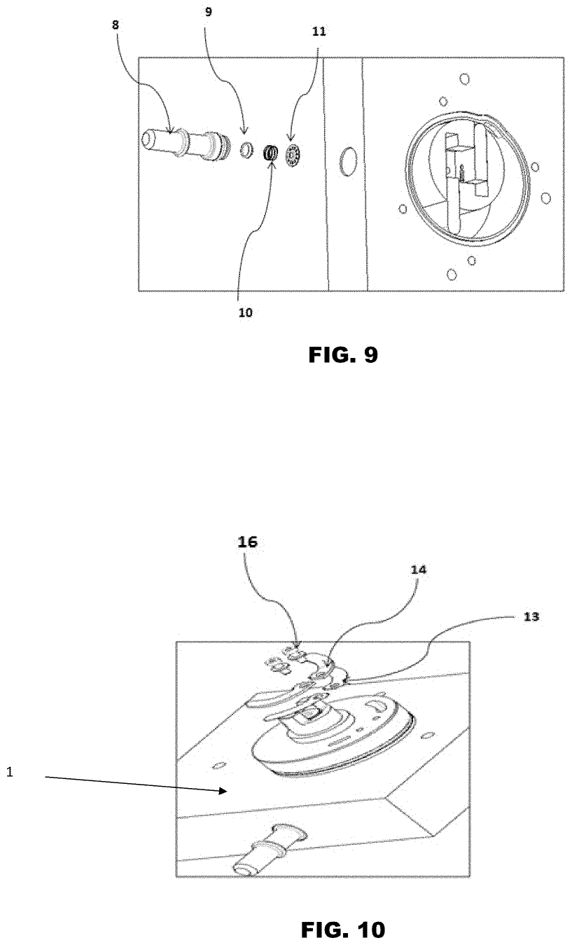

FIG. 9 is a plan view of the Non-Return Valve (NRV) assembly comprising of inlet connector 8, diaphragm 9, spring 10, and spring retainer 11. Diaphragm 9 is resting on inlet connector 8, through the action of spring 10 which is supported by spring retainer 11.

FIG. 10 is a plan view of the reed stopper assembly wherein sealing reed 13 is rest on the housing 1 and reed stopper 14 provides support for sealing reed 13. All parts are fastened by M4 screw 16.

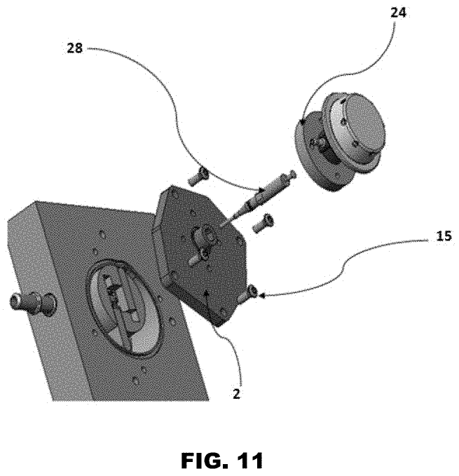

FIG. 11 is a plan view of the vacuum pump wherein cover 2 is assembled by four numbers of M6 screw 15 and actuator 24 is assembled in the shaft 28.

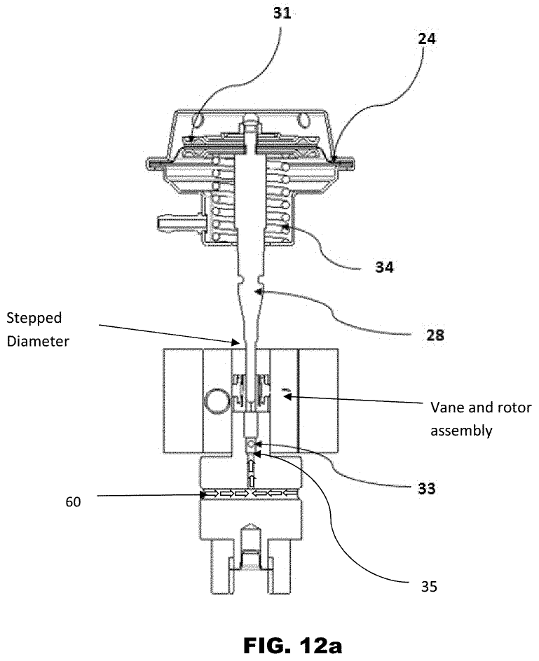

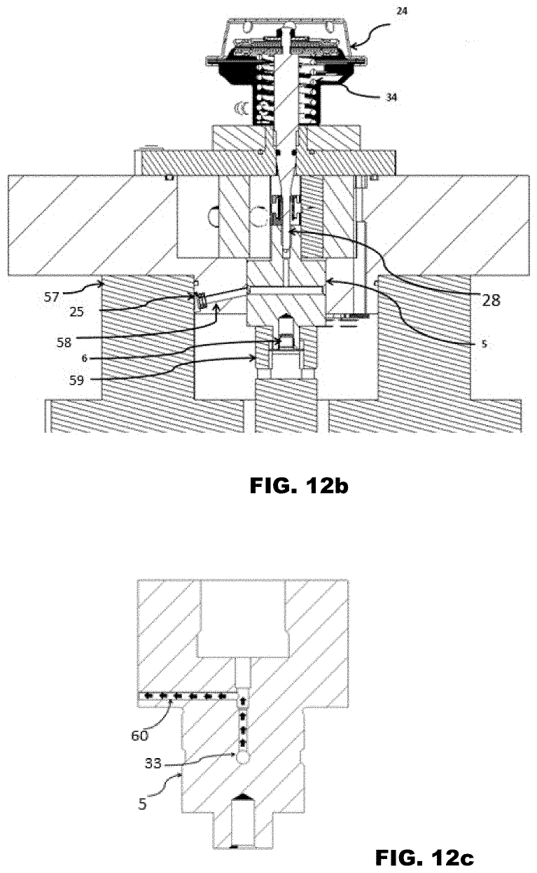

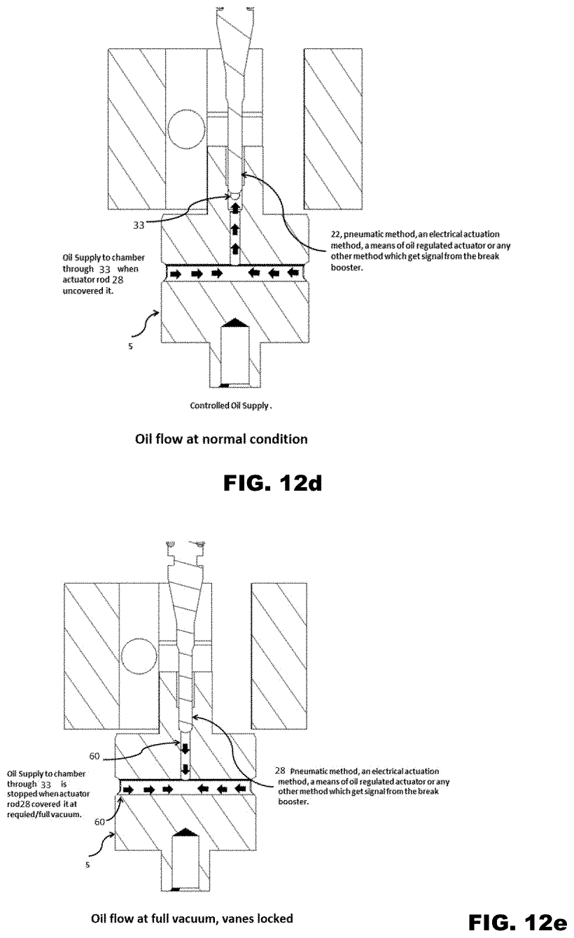

FIG. 12a represents the vane locking mechanism wherein the actuator 24 is connected to brake booster Tank. In actuator 24 there is assembly of diaphragm 31 and spring 34.

Once, the actuator 24 gets actuated through an external actuation system and the brake booster tank achieves full vacuum, the actuator 24 starts moving downwards that pushes the diaphragm 31 into downward direction; that allows spring 34 to compress and at the same time the vertical shaft 28 also starts moving downwards wherein the vertical shaft is having a stepped diameter with a leaner diameter at the tip and a preceding broader diameter. Due to stepped diameter of the shaft 28, initially leaner diameter is engaged in vane locking but as the shaft 28 moves in downward direction the preceding broader diameter engages in vane locking and causes said plurality of vanes locking adaptors 19 to move outwards and strike with the plurality of vanes 3A, 3B to block movement due to force applied by the plurality of disc springs 27. Rotor oil hole 33 is shown, 35 indicates controlled oil supply mechanism/means. Oil supply path 60 is shown by arrows.

In an embodiment, the actuator assembly on actuation, engages the shaft 28 having a stepped diameter, the narrow diameter portion of the shaft 28 engages with the vane locking assembly, but as the shaft 28 moves further downwards under actuation, the broader diameter portion of the shaft engages with the vane locking assembly and causes said plurality of vanes locking adaptors 19 to move outward and strike the plurality of vanes 3A, 3B to block movement of the shaft 28 due to a force applied by the plurality of disc springs 27, thereby reducing power loss and to regulate the oil supply to the vacuum pump preventing additional power loss due to continuous oil supply. The shaft 28 moves downwards striking in an oil inlet orifice 33 of the rotor 5 to block the oil supply.

The external actuation system includes: a pneumatic method i.e. pressure or vacuum, an electrical actuation method, oil regulated actuator means or any other method which get signal from the brake booster.

As shown in FIG. 12b, 12c, oil is supplied from the engine 57 head to the pump via the oil gallery 58 inside the engine head. The oil inlet orifice 25 holes over the engine head and pump body overlaps each other when pump is mounted over the engine head. So, the oil enters at certain pressure to the pump body by oil gallery from engine head and it reaches inside the rotor area and then to vacuum pump chambers in normal working condition.

But when maximum vacuum is achieved then the actuator rod/vertical shaft 28 goes downwards due to actuation and causes the hole 33 to get covered entirely. This restrict the oil entering to the vacuum pump chamber during full vacuum conditions and vanes in locked condition which are not sliding over the inner surface of housing profile as shown in FIG. 12d and FIG. 12d. And then again comes out through the exit port of the vacuum pump, and then to engine cam chamber and then to pump inside engine. So air is vented out to the environment and oil is recirculated inside the circuit for lubrication and sealing purpose.

After entering the pump chamber, the oil works as a lubricator inside the clearances and provide sealing effect. During exit stroke the mixture of oil and air sucked from the BBT is pushed out via the exit port of vacuum pump. The oil and air are then delivered inside the cam chamber clearances where it gets down the pump tank again. From there, oil is again pumped by oil pump towards the engine head and then it gets inside the vacuum pump through overlapped holes over component's mating surfaces.

In an embodiment of the present invention, the oil exits through the exit port of the vacuum pump which is covered by a sealing reed and reed stopper joined by spring washer and screw from opposite side to avoid any back flow of air inside the pump chamber. As it helps in oil and air mixture release to the outside of pump body from inside and also prevents any back flow from outside towards inside of the pump. So exit point for oil and air is common, as it vents out through the exit port which is prevented by a sealing reed. Sealing reed lifts at a particular pressure when pressure inside the exit stroke increase due to collected air and oil mixture, then venting of air and oil is done through it, both are released to the cam shaft chamber inside the engine.

In an embodiment, vacuum pressure is first maintained inside the brake booster tank (BBT) by creating vacuum pressure through vacuum pump. Hence the pressure when achieved its maximum value inside the BBT i.e. it hits 96±5 kPa due to working of vacuum pump, then ECU causes the solenoid valve to function and provide the certain amount of vacuum from BBT itself to the actuator device. This actuator device actuates and causes the stepped rod to get interfered against the cam mechanism locking adaptors which in result cause the outwards motion of the stoppers which will get tucked inside the slot in the vane to restrict the vane movement to the outside.

In another embodiment, oil is supplied to the pump via engine head. When pump is mounted over the engine head and its knob get engaged inside the cam shaft then the mating diametrical face of pump with engine head internal bore diameter cause two holes to overlap each other as one on pump and other over the engine bore diameter which becomes the passage of oil from engine to vacuum pump. Same is explained earlier in previous pages included oil supply channel.

In an embodiment, as is explained in locking mechanism of adapters 19 in brief that how stoppers cause the vane to get locked inside the rotor and will no more slide over the housing's inner profile consecutively decreasing the total area of contact during sliding inside the pump which results in low friction and also no exit or suction will also decrease total load which occurs on state of the art vane during normal condition. Hence the full vacuum condition at BBT enhances the pump performance in terms of power consumption as compared to existing design.

### Example 1

### Determining the Performance of Vacuum Pump

Two trials have been done to determine the power consumption of the present invention's novel design and the details of experiment along with drawings and quantitative data which mean same test is done twice to check the authenticity of component. To achieve the objective, the power consumption measured and suction performance is confirmed. The state of the art (existing design) vacuum pump is tested as per the described testing conditions ahead and same conditions are used for the present invention to compare the degradation in power consumption.

The samples are tested under same testing conditions to get the precise comparable results as follow:

Table 1 shows the testing condition for performing the suction test:

TABLE 1
Testing conditions & Specifications required

| | |
|---|---|
| Pump Speed | 425 ± 10 rpm |
| Rotation | Clockwise when viewing |
| | from cover side |
| Oil Temperature | 80 ± 3° C. |
| Oil pressure | 98 kPa |
| Lubricating Oil | SAE 5W30 |
| Ambient pressure | 101.3 kPa |
| Vacuum tank volume | 2.5 Liter |
| 80 kPa Vacuum Required in BBT | Max in 8 sec |
| 90 kPa Vacuum Required in BBT | Max in 12 sec |
| Max Vacuum Required in BBT | 96 ± 5 kPa |

Table 2 shows the testing condition for power consumption test:

TABLE 2
Testing conditions & Specifications required

| | |
|---|---|
| Pump Speed | 1000 ± 10 rpm |
| Rotation | Clockwise when viewing |
| | from cover side |
| Oil Temperature | 80 ± 3° C. |
| Oil pressure | 98 kPa |
| Lubricating Oil | SAE 5W30 |
| Ambient pressure | 101.3 kPa |
| Vacuum tank volume | 2.5 Liter |
| Average Diving Torque required | Max 0.4 Nm |

Results:

Following results has been obtained for the suction performance and torque testing—

Suction Test Results:

| | | Existing | | Novel |
|---|---|---|---|---|
| Suction Performance Specification | | Design | | Design |
| 80 kPa Vacuum Required in BBT | Max in 8 sec | 6.8 | sec | 7.2 |
| 90 kPa Vacuum Required in BBT | Max in 12 sec | 10.9 | sec | 11.4 |
| Max Vacuum Required in BBT | 96 ± 5 kPa | 94 | kPa | 95 kPa |

So with the change in concept and invetioned described, the present invention is meeting the required criteria of suction test.

Torque Test Results:

| | | | Novel | Novel |
|---|---|---|---|---|
| | | Existing | Design | Design |
| Torque test specification | | Design | trial 1 | trial 2 |
| Average Diving Torque | Max | 0.396 | 0.295 | 0.258 |
| required | 0.4 Nm | | | |

As per present novel design invention, due to vane locking mechanism at full vacuum 90 kPa or more as required, it causes the drastic decrease in the driving torque.

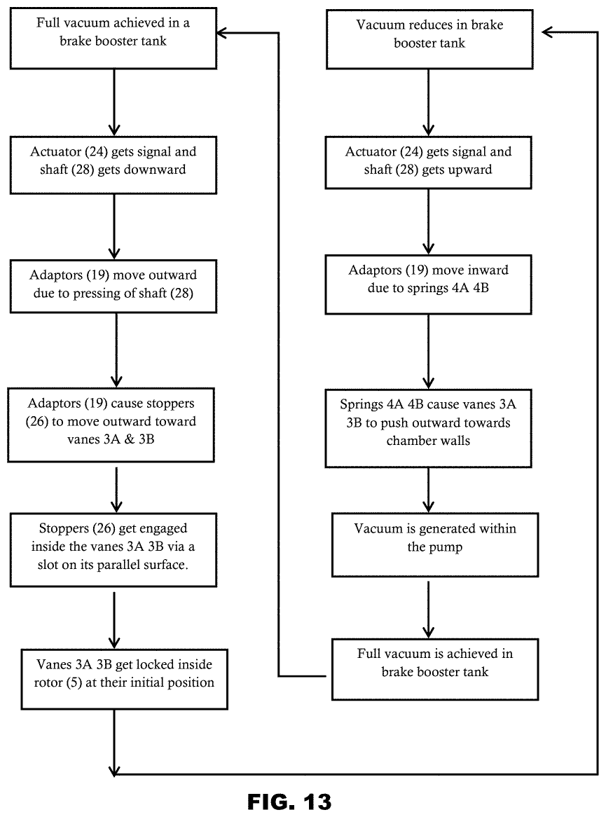

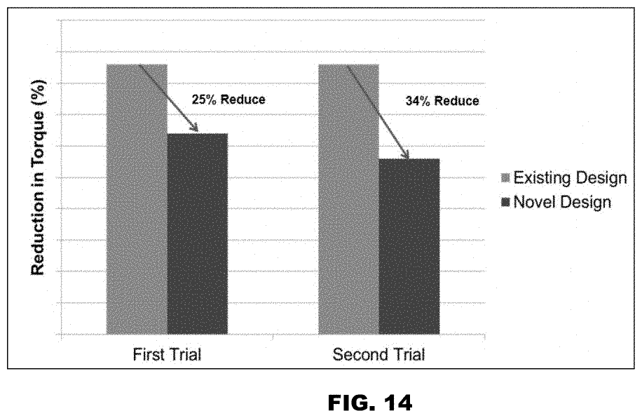

As vanes are no more sliding over the housing's inner profile and friction losses are reduced, this results into low power consumption of the pump. So this action causes the 25% decrease in driving torque (0.396 to 0.295) as compared in state of the art existing design in trial 1 and 34% decrease in driving torque (0.396 to 0.258) in trial 2 respectively in novel design. As depicted in FIG. 13, the comparative graph shows percent reduction in torque between conventional state of the art vacuum pump and novel vacuum pump according to the current invention. Two trials are conducted to compare performance of existing design and novel design of the vacuum pump according to the present invention and percent reduction in torque required for braking is noticed. It is surprisingly observed that the novel design of the vacuum pump reduces power consumption as a measure of 25-34% reduction of applied torque.

In an embodiment a method of reducing power loss and regulate controlled oil supply to the vacuum pump for automobiles to prevent additional power loss due to continuous oil supply via vane locking mechanism, the method comprising the steps of: activating actuator by achieving a desired vacuum in the brake booster tank that pushes the diaphragm in downward direction; that allows the spring to compress and the shaft starts moving into downward direction, due to stepped diameter of the shaft; engaging vane locking assembly to initially engage the lower diameter as the shaft moves in downward direction; and further engaging the larger diameter in vane locking and causing said plurality of vane locking adaptors to move into outward direction that strike with the plurality of vanes to block movement due to force applied by the plurality of disc springs. The desired vacuum pressure is in the range of 96±5 Kpa (720 mmHg). The main aspect is the requirement of full vacuum. Because when full vacuum 96±5 kPa is achieved in the brake booster tank then there is no need of vacuum pump to continue make vacuum inside brake booster tank. So the pressure gauge at the brake booster tank continue sense the value through its digital pressure sensor and if it lies in between 96±5 kPa, then ECU gets in action and cause the solenoid valve to operate. So operated solenoid valve cause the vacuum in the line to actuate the actuator for required operation. 95 kPa is the maximum vacuum in the brake booster tank which can be achieved by current novel design and lies under the specification of 96±5 kPa full vacuum required in brake booster tank. So, if vacuum pump is able to achieve the 95 kPa vacuum inside brake booster tank then it's the maximum limit after which no further vacuum generation is required from the vacuum pump because this amount of vacuum pressure is sufficient for braking 2-3 times inside the vehicle.

As shown in figures, the present invention utilizes the combined effects of less friction between the vane and the housing and optimized oil flow rate from the pressurized oil reservoir which results in less power consumption and running torque in more efficient and effective way over the existing vacuum pumps.

While the best mode has been described in detail, those familiar with the art will recognize various alternative designs and examples within the scope of the following claims.

We claim:

1. A vacuum pump for an automobile engine comprising:
an actuator assembly (24) comprising of a diaphragm (31), a spring (34), a movable vertical shaft (28), and an oil supply path (60);
a vane locking assembly comprising a vane locking sub-assembly assembled with a rotor (5);
a non return valve assembly;
a controlled oil supply means (35); and
a reed stopper assembly;
wherein:
the movable vertical shaft (28) has a stepped diameter with a narrow diameter at the tip and a preceding broader diameter;
the rotor (5) is provided with a plurality of vanes (3A, 3B), each vane of said plurality of vanes connected to a plurality of compressible springs (4A, 4B) thus forming a vane and rotor assembly;
the vane locking sub-assembly comprises a plurality of stoppers (26) resting on a plurality of disc springs (27), and a plurality of vane locking adaptors (19) connected to a plurality of extension springs (20);
the rotor (5) causes the movement of the vane in a rotary and reciprocating motion; the locking cap (7) restricts movement of the rotor in an axial direction preventing the knob (6) from coming out of the rotor; and vane tips (37) sweep the air and oil in a closed chamber (36);
the vane and rotor assembly, further comprises a housing (1) connecting engine (57); a knob (6) with a locking cap (7), said knob (6) connecting the engine camshaft (59) and transmitting power and torque to the vacuum pump;
the non-return valve assembly comprises an inlet connector (8), a diaphragm (9), a spring (10) and a spring retainer (11) wherein said diaphragm (9) is resting on said inlet connector (8) through the action of said spring (10) which is supported by said spring retainer (11) allowing the air in one direction only; and
the reed stopper assembly comprises a sealing reed (13), a reed stopper (14) and a spring washer, screwed on to the housing (1) to allow the oil to exit and prevent air leakage.

2. The vacuum pump as claimed in claim 1, wherein the actuator (24) upon actuation, moves the diaphragm (31) and the spring (34) driving the movable vertical shaft (28) downward under low vacuum to interrupt the oil supply path.

3. The vacuum pump as claimed in claim 1, wherein the controlled oil supply means (35) is provided by an oil inlet orifice (33) and the movable vertical shaft (28).

4. The vacuum pump as claimed in claim 1, wherein the power consumption is reduced by 25-34% of applied torque.

5. The vacuum pump as claimed in claim 1, wherein the actuation initiates at a vacuum pressure of 96+/−5 kPa.

6. The vacuum pump as claimed in claim 1, wherein the movable vertical shaft (28) moves downwards striking in an oil inlet orifice (33) of the rotor (5) to block the oil supply.

7. The vacuum pump as claimed in claim 1, wherein the actuator assembly on actuation, engages the movable vertical shaft (28) having a stepped diameter, the narrow diameter portion of the movable vertical shaft (28) engages with the vane locking assembly, but as the movable vertical shaft (28) moves further downwards under actuation, the broader diameter portion of the movable vertical shaft engages with the vane locking assembly and causes said plurality of vanes locking adaptors (19) to move outward and strike the plurality of vanes (3A, 3B) to block movement of the shaft (28) due to a force applied by the plurality of disc springs (27), thereby reducing power loss and to regulate the oil supply to the vacuum pump preventing additional power loss due to continuous oil supply.
